(19) United States
(12) Patent Application Publication
(10) Pub. No.: US 2017/0062125 A1
(43) Pub. Date: Mar. 2, 2017

(54) METHOD FOR MANUFACTURING COIL LOADING BOARD

(71) Applicant: Foxconn Technology Co., Ltd., New Taipei (TW)

(72) Inventor: Chia-Chin LEE, New Taipei (TW)

(21) Appl. No.: 14/881,279

(22) Filed: Oct. 13, 2015

(30) Foreign Application Priority Data
Aug. 26, 2015 (TW) 104127935

(51) Int. Cl. H01F 41/02

(52) U.S. Cl. CPC H01F 41/0206

(57) ABSTRACT

A method for manufacturing a coil loading board includes following steps: providing a first plate configured single-side adhesive and double-side adhesive on both sides thereof; defining a first slot, a first through hole, a first connection hole and a groove through both sides of the first plate; providing a second plate configured double-die adhesive on a side thereof; forming a second slot, a second through hole and a second connection hole through both sides of the second plate; fixing the first plate and the second plate together; removing the single-side adhesive of the first plate.

### CROSS-REFERENCE TO RELATED APPLICATIONS

This application claims priority to Chinese Patent Application No. 104127935 filed on Aug. 26, 2015, the contents of which are incorporated by reference herein.

### FIELD

The subject matter herein generally relates to a method for manufacturing a coil loading board.

### BACKGROUND

A wireless charging module is always configured in more and more electrical devices for wireless charging. The wireless charging module includes a loading board and a coil configured on the loading board. Generally, a plurality of through holes and grooves are formed through the loading board for receiving the coiling therein.

### BRIEF DESCRIPTION OF THE DRAWINGS

Implementations of the present technology will now be described, by way of example only, with reference to the attached figures.

FIG. 1 is a flow chart of a method for manufacturing a coil loading board of the present disclosure.

FIGS. 2-10 are isometric views showing the coil board of the present disclosure processed by various steps of FIG. 1.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. The description is not to be considered as limiting the scope of the embodiments described herein.

The term “comprising” means “including, but not necessarily limited to”; it specifically indicates open-ended inclusion or membership in a so-described combination, group, series and the like.

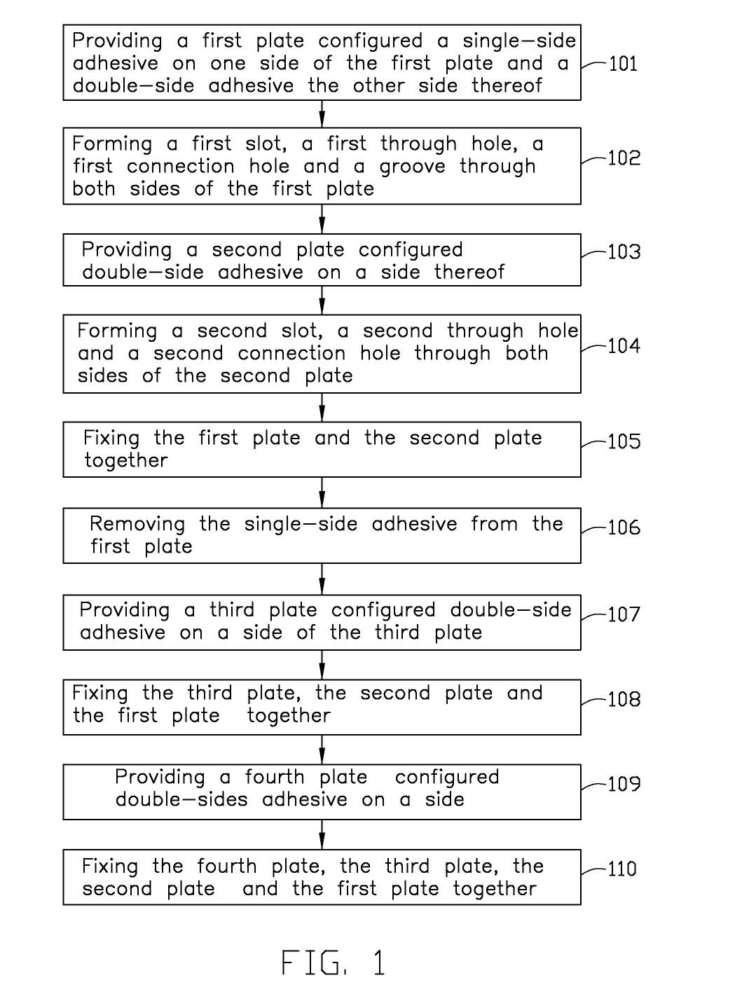

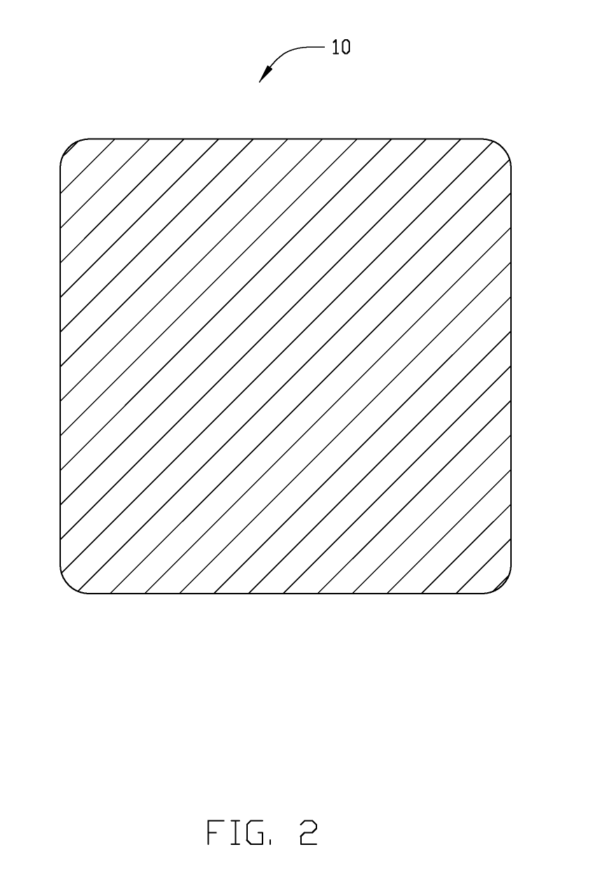

FIG. 1 illustrates a flow chart of a method for manufacturing a coil loading board of one embodiment of the present disclosure. The example method is provided by way of example, as there are a variety of ways to carry out the method. The method described below can be carried our using the configurations illustrated FIGS. 2-10, for example, and various elements of these figures are reference in explaining example method. Each block shown in FIG. 1 represents one or more processes, method or subroutines, carried out in the example method. Additionally, the illustrated order of block is by example only and the order of the blocks can change according to the present disclosure. The example method can begin at block 101.

At block 101, referring to FIG. 2, providing a first plate 10 configured a single-side adhesive on one side of the first plate 10 and a double-side adhesive the other side thereof.

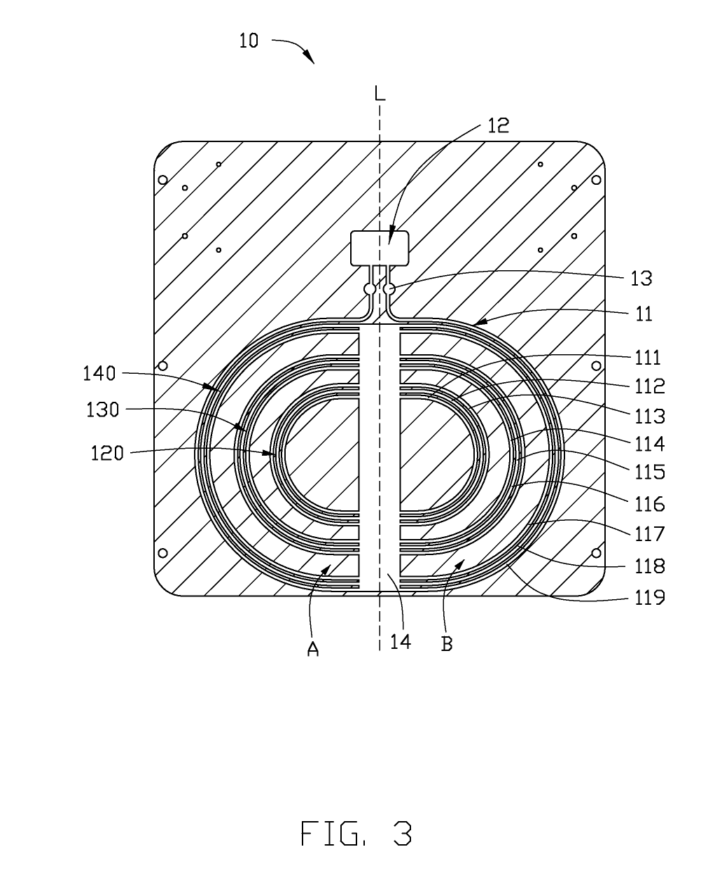

At block 102, referring to FIG. 3, defining a first slot 11, a first through hole 12, two first connection holes 13 and a groove 14 through both sides of the first plate 10.

The groove 14 can be rectangular and is located at a center of the first plate 10. The first plate 10 has an axis L which is coincident with an axis of the groove 14 and the first through hole 12. Specifically, the groove 14 is penetrates through a center of the first slot 11 to divide the first slot 11 into a first zone A and a second zone B. The first slot 11 is symmetrical about the groove 14.

In the illustrated embodiment, the groove 14, the first slot 11, the first through hole 12 and the first connection holes 13 can be defined by die cutting machine. A depth of the first slot 11, the first through hole 12, the first connection holes 13 and the groove 14 are equal to a thickness of the first plate 10. The first slot 11 includes a series of rounding gaps spaced from each other. The rounding gaps each surround an adjacent gap one after another. Specifically, the first slot 11 includes a first gap 111, a second gap 112, a third gap 113, a fourth gap 114, a fifth gap 115, a sixth gap 116, a seventh gap 117, a eighth gap 118 and a ninth gap 119 arranged from inside to outside. Further, the first gap 111, the second gap 112 and the third gap 113 together form a first group 120. A perimeter size of the first gap 111 is larger than a size of the second gap 112, and the perimeter size of the second gap 112 is larger than a perimeter size of the third gap 113. Perimeter sizes of the rounding gaps are arranged in that manner. The fourth gap 114, the fifth gap 115 and the sixth gap 116 together form a second group 130. The seventh gap 117, the eighth gap 118, and the ninth gap 119 together form a third group 140. A distance between the first group 120 and the second group 130 is equal to a distance between the second group 130 and the third group 140. In each group, a distance between the two adjacent gaps is the same, and is less than the distance between two adjacent groups. Each gap communicates with the groove 14 and is symmetrical about the groove 14.

The first through hole 12 is configured at an outer end of the first slot 11. The first connection holes 13 is configured between the first slot 11 and the first through hole 12. An end of the ninth gap 119 close to the first through hole 12 extends through the first connection hole 13 to communicate with the first through hole 12. The first connection hole 13 is configured for coupling to a circuit.

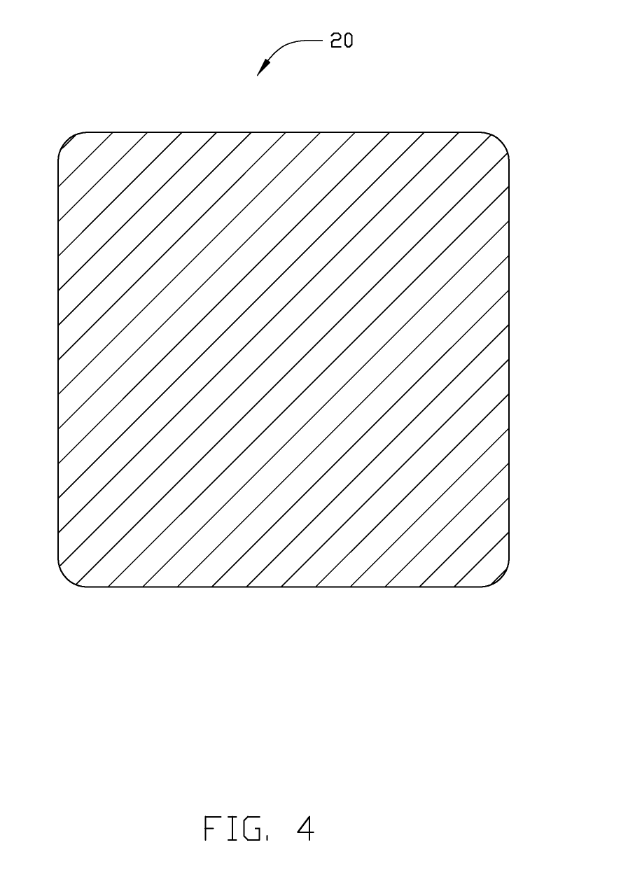

At block 103, referring to FIG. 4, providing a second plate 20 configured double-side adhesive on a side thereof.

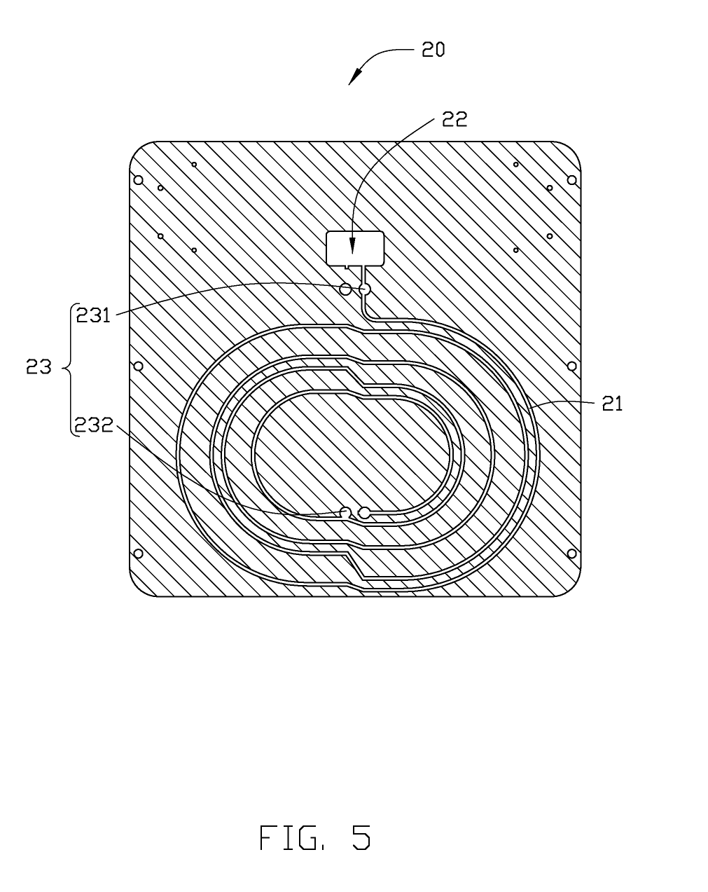

At block 104, referring to FIG. 5, defining a second slot 21, a second through hole 22 and fourth second connection holes 23 through both sides of the second plate 20.

The second slot 21, the second through hole 22 and the second connection hole 23 can be defined by die cutting machine. A depth of the second slot 21, the second through hole 22 and the second connection holes 23 is equal to a thickness of the second plate 20. The second slot 21 is a continuous rounding gap. While the second plate 20 is fixed with the first plate 10, the second slot 21 overlaps with the gaps of the first slot 11 in serious from inside to outside continuously, and connects two adjacent gaps of the first slot 11 at the groove 14 of the first plate 10. The second through hole 22 is configured at an outer end of the second slot 21 and is located corresponding to the first through hole 12. There are four second connection holes 23. Two of the second connection holes 23 also named as outer connection holes 231 are corresponding to the first connection holes 13 and are located between the second slot 21 and the second through hole 22. The other two of connection holes 23, also named as inner connection holes 232, spaced from each other are surrounded by the second slot 21 and connect with a inner end of the second slot 21. The second slot 21 begins from one of the inner connection holes 232 and an ourter end of the second slot 21 extends through one of the outer connection hole 231 to communicate with the second through hole 22.

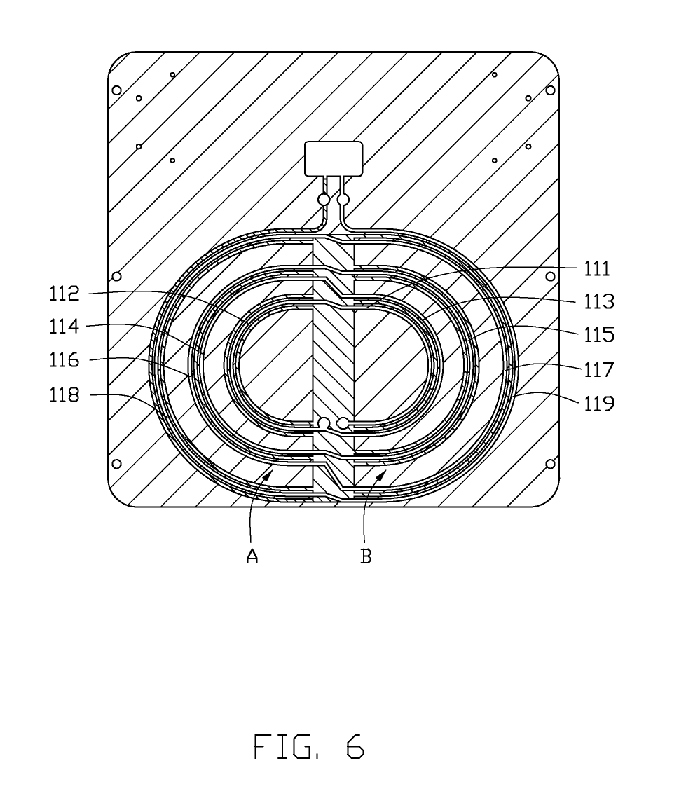

At block 105, referring to FIG. 6, fixing the first plate 10 and the second plate 20 together.

While the first plate 10 is fixed with the second plate 20 together, the second through hole 22 overlaps with the first through hole 12, the second connection hole 23 overlaps with the first connection hole 13. The second slot 21 overlaps with the gaps of the first slot 11 from inside to outside. Specifically, at the first zone A, the second slot 21 overlaps the second gap 112, the fourth lap 114, the sixth lap 116, the eighth lap 118 of the first slot 11; at the second zone B, the second slot 21 overlaps the first gap 111, the third gap 113, the fifth gap 115, the seventh gap 117 and the ninth gap 119 of the first slot 11.

At block 106, removing the single-side adhesive from the first plate 10.

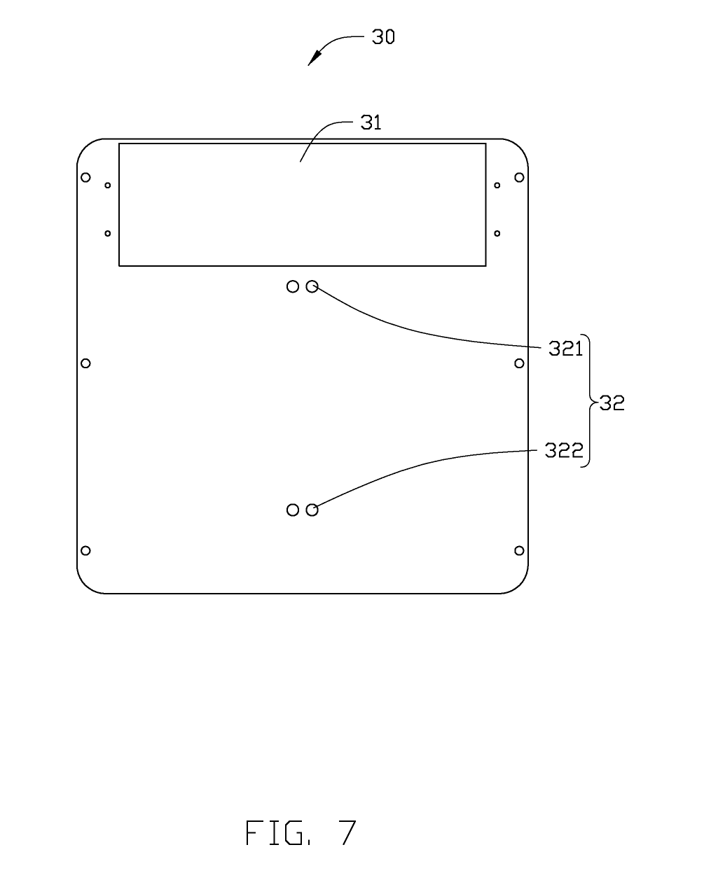

At block 107, referring to FIG. 7, providing a third plate 30 configured double-side adhesive on a side of the third plate 30.

The third plate 30 defines a third through hole 31 and four third connection holes 32 through both sides thereof. The third through hole 31 is rectangular. A size of the third through hole 31 is larger than that of the first through hole 12 of the first plate 10. The four third connection hole 32 are spaced from each other, including two upper connection holes 321 and two lower connection holes 322. The two upper connection holes 321 are located between the two lower connection holes 322 and the third through hole 31. The upper connection holes 321 are also corresponding to both the first connection holes 13 and the outer connection holes 231. The lower connection holes 322 are corresponding to the inner connection holes 232.

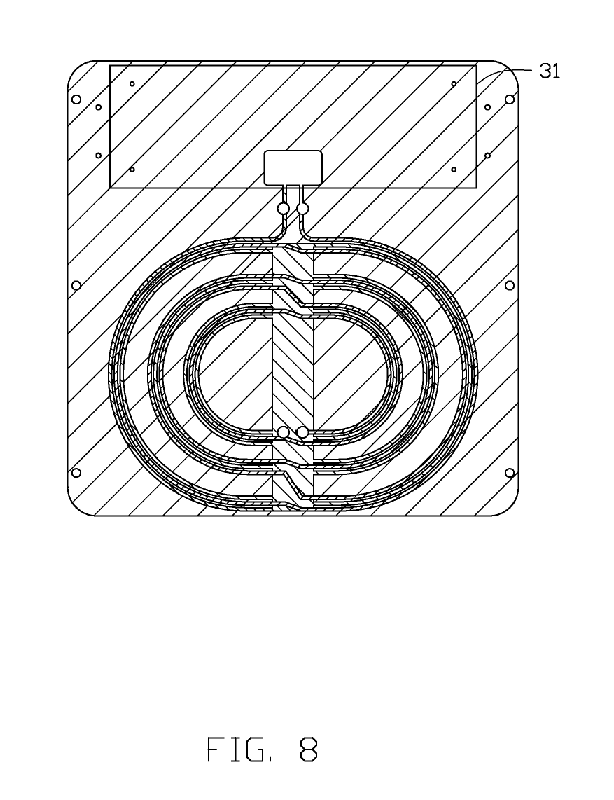

At block 108, referring to FIG. 8, fixing the third plate 30, the second plate 20 and the first plate 10 together. The second plate 20 is located between the first plate 10 and the third plate 30. The first through hole 12 and the second through hole 22 are overlapped each other. The first connection hole 13, the second connection holes 23 and the third connection holes 32 are overlapped each other.

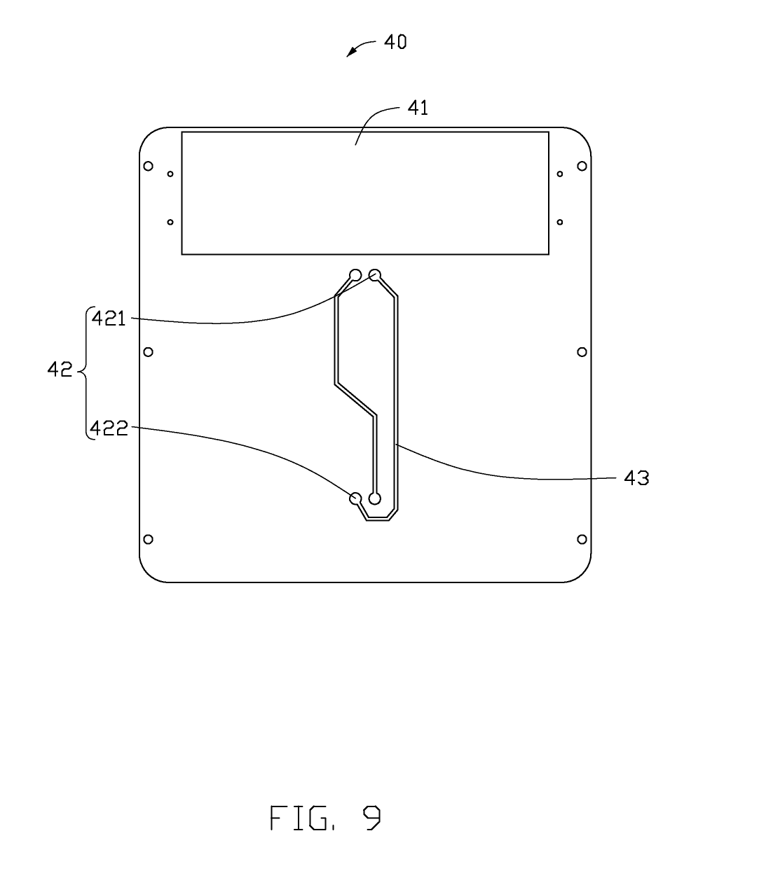

At block 109, referring to FIG. 9, providing a fourth plate 40 configured double-sides adhesive on a side.

The fourth plate 40 defines a fourth through holes 41, four fourth connection holes 42 and two connecting channels 43 through both sides thereof. The fourth through holes 41 is corresponding with the third through holes 31 of the first plate 30. The fourth connection holes 42 are configured as and corresponding to the third connection holes 32 of the third plate 30, including two upper connection holes 421 and two connection holes 422. The two upper connection holes 421 are located between two lower connection holes 322 and the fourth through hole 41. The upper connection holes 421 are also corresponding to the upper connection holes 321 of the third plate 30. The lower connection holes 422 are corresponding to the lower connection holes 322 of the third plate 30. The connecting channels 43 respectively extends through two diagonal the upper connection holes 421 and the lower connection holes 422 to communicate with thereof.

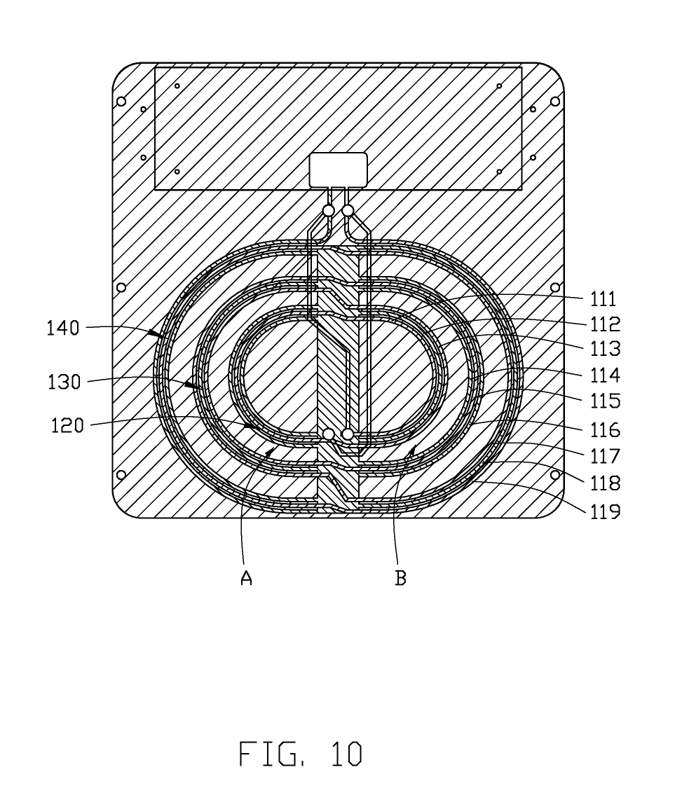

At block 110, referring to FIG. 10, fixing the fourth plate 40, the third plate 30, the second plate 20 and the first plate 10 together. Specifically, the fourth plate 40 is pasted on a side of the first plate 30. The fourth through hole 41 and the third through hole are overlapped with each other. The fourth connection holes 42 and the third connection holes 32 are overlapped with each other. Thus, the coil lading board is manufactured completely.

In the illustrated embodiment, at block 106, selectively including cutting the second plate 20 along the first slot 11 of the first plate 10 by die cutting machine. A processing depth of the cutting machine is larger than the thickness of the first plate 10 and less than the depth of a sum of the thickness of the first plate 10 and the second plate 20. In the cutting process, only the second first gap 111, the third gap 113, the fifth gap 115, the seventh gap 117 and the ninth gap 119 of the first zone A are cut, and only the second gap 112, the fourth gap 114, the sixth gap 116 and the eighth gap 118 of the second zone B are cut.

The embodiments shown and described above are only examples. Many details are often found in the art such as the other features of a method for manufacturing a coil loading board. Therefore, many such details are neither shown nor described. Even though numerous characteristics and advantages of the present technology have been set forth in the foregoing description, together with details of the structure and function of the present disclosure, the disclosure is illustrative only, and changes can be made in the detail, including in matters of shape, size and arrangement of the parts within the principles of the present disclosure up to, and including the full extent established by the broad general meaning of the terms used in the claims. It will therefore be appreciated that the embodiments described above can be modified within the scope of the claims.

What is claimed is:

1. A method for manufacturing a coil loading board, comprising:
providing a first plate configured a single-die adhesive on one side of the first plate;
defining a first slot, a first through hole, two first connection holes and a groove through both sides of the first plate, the first slot comprising a series of rounding gaps spaced from each other, the first slot communicating with the first through hole through hole, and the first slot being symmetrical about the groove;
providing a second plate;
defining a second slot, a second through hole and four second connection holes through both sides of the second plate, the second slot being a continuous rounding gap; and
fixing the first plate and the second plate together, the second slot overlapping the first slot in serious and connects two adjacent gaps of the first slot at the groove, and the first through hole overlapping the second through hole.

2. The method of claim 1, wherein a depth of the first slot, the first through hole, the first connection holes and the groove are equal to a thickness of the first plate.

3. The method of claim 2, wherein the first slot comprises three groups arranged from inside to outside, each group comprises a series of rounding gaps spaced from each other, the rounding gaps each surround an adjacent rounding gap one after another.

4. The method of claim 3, wherein, a distance between the two adjacent gaps is the same, and is less than a distance between two adjacent groups.

5. The method of claim 3, wherein the groove penetrates through a center of the first slot to divide the first slot into a first zone A and a second zone B.

6. The method of claim 3, wherein the first connection holes are configured between the first slot and the first through hole.

7. The method of claim 3, wherein a depth of the second slot, the second through hole and the second connection holes is equal to a thickness of the second plate.

8. The method of claim 2, wherein the first through hole is configured at an outer end of the first slot, an end of an outermost gap of the first slot close to the first through hole extends through the first connection holes to communicate with the first through hole.

9. The method of claim 1, wherein the second through hole and the second connection holes are respectively corresponding with the first through hole and the first connection holes of the first plate.

10. The method of claim 1, wherein after fixing the first plate and the second plate together, further comprising removing the single side adhesive from the first plate.

11. The method of claim 10, wherein after removing the single side adhesive form the first plate, comprising cutting the second the second plate along the first slot of the first plate by die cutting machine.

12. The method of claim 11, wherein a processing depth of die cutting machine is larger than the thickness of the first plate and less than the depth of a sum of the thickness of the first plate and the second plate.

13. The method of claim 11, wherein a process depth of die cutting machine is larger than the thickness of the first plate and equal to the depth a sum of the thickness of the first plate and the second plate.

14. The method of claim 13, wherein the third plate defines a third through hole and four third connection holes through both side thereof, a size of the third through hole is larger than that of the first through hole, the third connection holes are corresponding with both the first connection holes and second connection holes.

15. The method of claim 1, wherein comprising providing a third plate configured a double-side adhesive on a side of the third plate and fixing the third plate, the second plate and the first plate together.

16. The method of claim 1, wherein comprising providing a fourth plate configured a double-sides adhesive on a side, and fixing the fourth plate, the third plate, the second plate and the first plate together.
